(19) United States
(12) Patent Application Publication
(10) Pub. No.: US 2025/0153050 A1
(43) Pub. Date: May 15, 2025

(54) High Frame Rate Light Beam Collision Detection

(71) Applicant: Disney Enterprises, Inc., Burbank, CA (US)

(72) Inventors: Jack Wetherell, Los Angeles, CA (US); Nicholas Shelton, Los Angeles, CA (US); Brandon Newberg, Irvine, CA (US); Prutsdom Jiarathanakul, Los Angeles, CA (US); Michael IIardi, Los Angeles, CA (US)

(21) Appl. No.: 18/389,346

(22) Filed: Nov. 14, 2023

(51) Int. Cl. A63F 13/65; A63F 13/216; A63F 13/577; G06F 3/03; G06T 7/277; G06T 19/00; G06V 20/50

(52) U.S. Cl. CPC A63F 13/65; A63F 13/216; A63F 13/577; G06F 3/0304; G06T 7/277; G06T 19/00; G06V 20/50

(57) ABSTRACT

A system includes a computing platform having a hardware processor and a memory storing a software code, a video camera communicatively coupled to the computing platform, and a user device communicatively coupled to the computing platform, the user device including a position/location (P/L) detection unit. The hardware processor is configured to execute the software code to obtain a three-dimensional (3D) map of a physical venue, identify one or more object representations within the physical venue, and detect, using the video camera, a collision of a light beam emitted by the user device with one of the one or more object representations. The hardware processor is further configured to execute the software code to identify, based on the 3D map and an orientation data sampled from the P/L detection unit, the user device having emitted the light beam colliding with the one of the one or more object representations.

### BACKGROUND

Traditional shooting gallery type attractions typically use physical targets to create a game environment with which users can interact. As computer technology continues to improve, more modern versions of those types of attractions increasingly make use of projection mapping on dimensional scenery. That is to say, targets may no longer be static physical objects, but may be digital representations of objects that are capable of moving across arbitrary surfaces present in the physical venue providing the shooting gallery type attraction.

However, these modern media driven approaches that utilize projection mapping on dimensional scenery are incompatible with the technology traditionally deployed in other shooting gallery type attractions where the targets are fixed. Thus, there is a need in the art for a new method for determining where a user is aiming or otherwise pointing a projection device in use cases in which the pointing position of the user must be captured and accurately translated from the real-world space of the physical venue of the attraction to a virtual space, such as a “game space” at a high frame rate due to the contemporaneous use of many projection devices by many users.

### BRIEF DESCRIPTION OF THE DRAWINGS

FIG. 1 shows a diagram of a high frame rate light beam collision detection system, according to one exemplary implementation;

FIG. 2 shows a conceptual diagram of a physical venue in which the high frame rate light beam collision detection system of FIG. 1 is utilized, according to one implementation;

FIG. 3 shows a more detailed diagram of a user device of the high frame rate light beam collision detection system of FIG. 1, communicatively coupled to a computing platform of that system, according to one implementation; and

FIG. 4 shows a flowchart presenting an exemplary method for performing high frame rate light beam collision detection, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals.

As stated above, traditional shooting gallery type attractions typically use physical targets to create a game environment with which users can interact. As computer technology continues to improve, more modern versions of those types of attractions increasingly make use of projection mapping on dimensional scenery. Consequently, targets may no longer be static physical objects, but may be digital representations of objects that are capable of moving across arbitrary surfaces present in the physical venue providing the shooting gallery type attraction.

However, and as also stated these modern media driven approaches that utilize projection mapping on dimensional scenery are incompatible with the technology traditionally deployed in other shooting gallery type attractions where the targets are fixed. Thus, there is a need in the art for a new method for determining where a user is aiming or otherwise pointing a projection device in use cases in which the pointing position of the user must be captured at a high frame rate and accurately translated from the real-world space of the physical venue of the attraction to a virtual space, such as a “game space.” at a high frame rate due to the contemporaneous use of many projection devices by many users.

The present application is directed to high frame rate light beam collision detection systems and methods that address and overcome the deficiencies in the conventional art. The novel and inventive concepts disclosed in the present application advance the state-of-the-art by synchronizing image data sampled from one or more video cameras with orientation data sampled from a position/location (P/L) detection unit of a respective projection device (hereinafter “user device”) utilized by each of multiple users. That synchronized image and orientation data can advantageously be used to identify the particular user device that emitted a light beam having collided with an object representation in the form of a digital projection that may move across arbitrary surfaces in a three-dimensional (3D) physical venue. It is noted that, in addition to projection mapping on dimensional scenery, the present novel and inventive concepts are applicable to other display techniques, such as those using large display screens or light-emitting diode (LED) surfaces of various shapes, including LED walls and domes, for example. Moreover, the present solution may be implemented as substantially automated systems and methods.

As defined in the present application, the terms “automation,” “automated,” and “automating” refer to systems and processes that do not require human intervention. Although in some implementations a human operator may supervise the high frame rate light beam collision detection systems using the methods described herein, that human involvement is optional. Thus, the methods described in the present application may be performed under the control of hardware processing components of the disclosed automated systems.

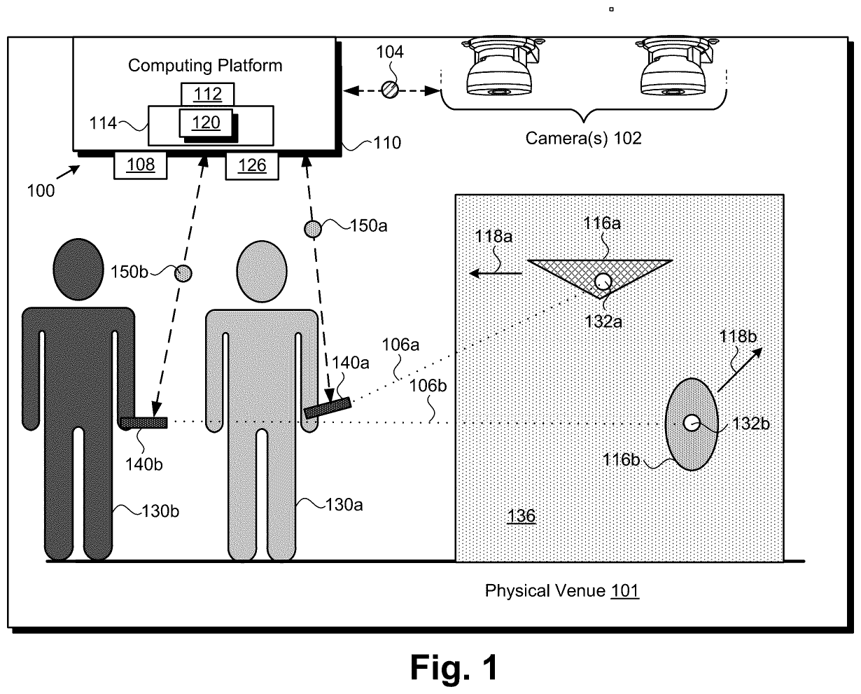

FIG. 1 shows a diagram of high frame rate light beam collision detection system 100 (hereinafter “system 100”), according to one exemplary implementation. As shown in FIG. 1, system 100 includes computing platform 110 having hardware processor 112 and memory 114 implemented as a non-transitory storage medium containing software code 120. In addition, system 100 includes one or more cameras 102 (hereinafter “camera(s) 102”) and user devices 140a and 140b each communicatively coupled to computing platform 110. As further shown in FIG. 1, in some implementations, system 100 may also include one or both of game engine 108 and 3D mapping device 126 communicatively coupled to computing platform 110.

It is noted that, as defined for the purposes of the present application, the expression “communicatively coupled” may mean physically integrated with, or physically discrete from but in communication with. Thus, one or more of video camera(s), game engine 108 and 3D mapping device 126 may be integrated with computing platform 110, or may be adjacent to or remote from computing platform 110 while being in wired or wireless communication with computing platform 110. It is noted that user devices 140a and 140b are handheld devices that, while physically separate from computing platform 110, are in wired or wireless communication with computing platform 110

As further shown in FIG. 1, system 100 is implemented within real-world physical venue 101 (hereinafter “physical venue 101”) including one or more arbitrary surfaces 136 (hereinafter “surface(s) 136”), which may be 3D surfaces for example, on which object representations 116a and 116b in the form of respective digital representations of objects that are projected onto surface(s) 136 move with respective velocities, i.e., speed and direction, 118a and 118b. In addition, FIG. 1 shows users 130a and 130b of respective user devices 140a and 140b, light beams 106a and 106b emitted by respective user devices 140a and 140b, as well as collision 132a of light beam 106a emitted by user device 140a with object representation 116a, and collision 132b of light beam 106b emitted by user device 140b with object representation 116b. Also shown in FIG. 1 are image data 104 sampled by computing platform 110 from camera(s) 102 and orientation data 150a and 150b sampled by computing platform 110 from respective P/L detection units of user devices 140a and 140b (P/L detection units not shown in FIG. 1).

It is noted that although FIG. 1 depicts two users 130a and 130b utilizing two respective user devices 140a and 140b, and two object representations 116a and 116b, that representation is merely provided by way of example. In various implementations, physical venue 101 may include as few as one object representation, i.e., one of object representations 116a or 116b, or more than two object representations. Moreover, it is contemplated that in most use cases, more than two users 130a and 130b utilizing more than two respective user devices 140a and 140b will interact contemporaneously with features of physical venue 101, such as ten, fifty, or one hundred users corresponding to users 130a and 130b each utilizing a respective one of ten, fifty, or one hundred user devices corresponding to user devices 140a and 140b.

It is further noted that in various use cases, physical venue 101 may take the form of a classroom, a lecture hall, a conference room, a convention center, a theme park attraction, a cruise ship, a game environment, or a film or broadcast studio, to name a few examples. Camera(s) 102 may include one or more infrared-sensitive (IR-sensitive) still image cameras and/or video cameras, as well as one or more red-green-blue (RGB) still image cameras and/or video cameras. Moreover, in some implementations, camera(s) 102 may correspond to an array of IR-sensitive or RGB still image and/or video cameras configured to perform a panoramic image capture of a physical venue 101.

It is also noted that although the present application refers to software code 120 as being stored in memory 114 for conceptual clarity, more generally, memory 114 may take the form of any computer-readable non-transitory storage medium. The expression “computer-readable non-transitory storage medium,” as defined in the present application, refers to any medium, excluding a carrier wave or other transitory signal that provides instructions to hardware processor 112 of computing platform 110. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM) and FLASH memory.

Moreover, in some implementations, system 100 may utilize a decentralized secure digital ledger in addition to, or in place of, memory 114. Examples of such decentralized secure digital ledgers may include a blockchain, hashgraph, directed acyclic graph (DAG) and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

Although FIG. 1 depicts software code 120 as being stored in its entirety in a single instantiation of memory 114, that representation is also merely provided as an aid to conceptual clarity. More generally, system 100 may include one or more computing platforms 110, such as computer servers for example, which may be co-located, or may form an interactively linked but distributed system, such as a cloud-based system, for instance. As a result, hardware processor 112 and memory 114 may correspond to distributed processor and memory resources within system 100.

Hardware processor 112 may include multiple hardware processing units, such as one or more central processing units, one or more graphics processing units and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU) and “tensor processing unit” (TPU) have their customary meaning in the art. That is to say, a CPU includes an Arithmetic Logic Unit (ALU) for carrying out the arithmetic and logical operations of computing platform 110, as well as a Control Unit (CU) for retrieving programs, such as software code 120, from memory 114, while a GPU may be implemented to reduce the processing overhead of the CPU by performing computationally intensive graphics or other processing tasks. A TPU is an application-specific integrated circuit (ASIC) configured specifically for artificial intelligence (AI) processes such as machine learning.

System 100 may be configured to support wireless communication with camera(s) 102 and user devices 140a and 140b via one or more of a variety of wireless communication protocols. For example, system 100, camera(s) 102 and user devices 140a and 140b may be configured to communicate using fourth generation (4G) wireless communication technology and/or a 5G wireless communication technology. In addition, or alternatively, system 100, camera(s) 102 and user devices 140a and 140b may be configured to communicate using one or more of Wireless Fidelity (Wi-Fi®), Worldwide Interoperability for Microwave Access (WiMAX®), Bluetooth®, Bluetooth® low energy (BLE), ZigBee®, radio-frequency identification (RFID), near-field communication (NFC) and 60 GHz wireless communications methods. Moreover, in some implementations, system 100, camera(s) 102 and user devices 140a and 140b may be configured to communicate using a high-speed network suitable for high performance computing (HPC), for example a 10 GigE network or an Infiniband network.

In some implementations, computing platform 110 may correspond to one or more web servers accessible over a packet-switched network such as the Internet, for example. Alternatively, computing platform 110 may correspond to one or more computer servers supporting a wide area network (WAN), a local area network (LAN), or included in another type of private or limited distribution network. In addition, or alternatively, in some implementations, system 100 may utilize a local area broadcast method, such as User Datagram Protocol (UDP) or Bluetooth®, for instance. Furthermore, in some implementations, computing platform 110 may be implemented virtually, such as in a data center. For example, in some implementations, computing platform 110 may be implemented in software, or as virtual machines.

In addition to a P/L detection unit, each of user devices 140a and 140b is equipped with a light emission source serving as the source of respective light beams 106a and 106b. For example, the light emission source included in each of user devices 140a and 140b may be an IR light source, such as an IR laser for example, or another emission source of light outside of the human visual spectrum, and may, in some implementations, be generated by an LED. Accordingly, camera(s) 102 may be specifically configured to detect IR light or other light invisible to human users 130a and 130b of respective user devices 140a and 140b.

By way of overview, it is noted that a reliable way to determine where a user is aiming or pointing is to give that user a projection device such as one of user devices 140a or 140b that projects light in the IR spectrum, for example, creating an IR dot or patterned IR light. This IR light can then be detected by IR-sensitive camera(s), such as camera(s) 102, within the field of view of camera(s) 102, but problems typically arise when it is necessary to distinguish between IR dots projected from different user devices, as well as to translate the position of the IR dots into a virtual game.

The high frame rate light beam collision detection solution disclosed in the present application translates from two-dimensional (2D) views of collisions of light beams 106a and 106b with surface(s) 136 within physical venue 101 captured by camera(s) 102, into usable coordinates for a laser pointing use case or shooting gallery type game, utilizing an auto-calibration technique. By capturing structured light scans of physical venue 101 with camera(s) 102, which are used to track the aiming or pointing position of each user, lookup tables can be generated that allow for the translation between a coordinate within each camera (“camera space”), to a coordinate within each screen or projector (“projection space”) that can then be useable by the game or other use case application. This present method advantageously ensures that the area at which a user is aiming or pointing in physical venue 101 is aligned with pixels from the media that comprises the game or other use case application, including object representations 116a and 116b serving as targets.

After the position of a given collision between a light beam and a surface within physical venue 101 is detected, several possible conventional methods can be employed to distinguish which light beam was projected by which of user devices 140a and 140b. However, those conventional methods often degrade the frame rate at which the aiming or pointing position of a particular user can be detected. For example, if one user device is activated per frame, and there are fifty users each utilizing a respective one of fifty user devices in physical venue 101, and the light beam collision detection occurs at two hundred frames-per-second (200 FPS), the resultant frame rate is reduced to 4 FPS per user device, which is unacceptable for most applications. As the number of users in the attraction increases, a method to upscale the light beam collision measurements back to a usable frame rate is needed.

The present high frame rate light beam collision detection solution for distinguishing between light beams projected by different user devices utilized by different users is to employ time-multiplexing enhanced by upscaling methods. For example, the present application introduces a novel application of Kalman filters to upscale light beam collision measurements sampled from camera(s) 102 and fuse that image data 104 with orientation data 150a and 150b sampled from respective P/L detection units of user devices 140a and 140b. Estimates of the position of each light beam collision can then be made between light detection measurements, using the orientation data, which may be sampled more frequently than image data 104. That is to say, image data 104 and orientation data 150a and 150b may be sampled at different sampling rates.

The P/L detection unit of each of user devices 140a and 140b, which may be an inertial measurement unit (IMU) for example, provides a measurement of the rotational angular velocity of each user device that can be spherically projected to give an estimate of the linear velocity of the light beam collision on surface(s) 136 within physical venue 101. This estimate can be used to create a very high accuracy and low latency sensor fusion system that can be used to upscale the IR or other light measurements back to the full FPS rate of the system.

The structured light scan using camera(s) 102 also provides a reconstruction of physical venue 101 that is useful for the upscaling processes. Both the depth of physical venue 101, as well as the skew of each of surface(s) 136 relative to the ground can be used as inputs to the Kalman filter that upscales the input received from each of user devices 140a and 140b. In addition, in implementations in which the P/L detection unit is implemented as an IMU, the present solution is especially robust as the IMU measurements can be globally defined using the IMU gravity gyroscopic sensor and internal compass, ensuring accurate results regardless of exact IMU mounting on the user device in a calibration-free approach.

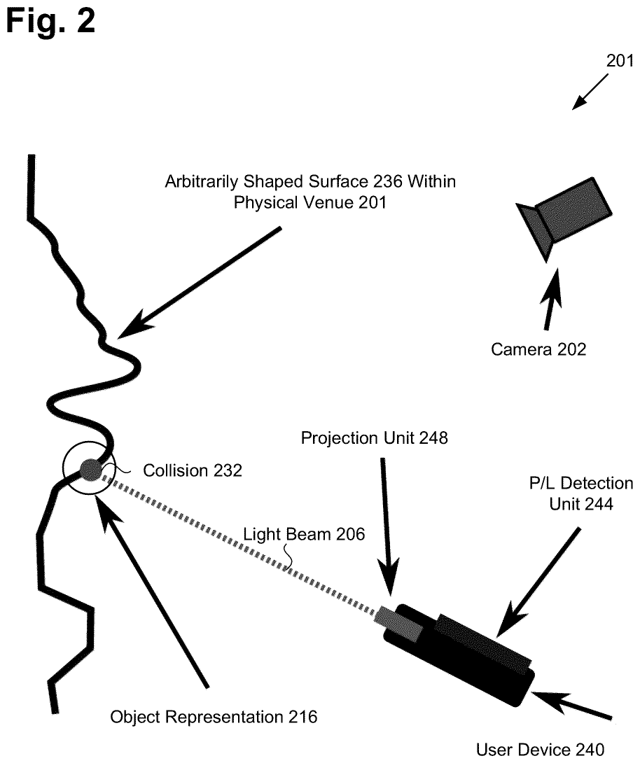

FIG. 2 shows a conceptual diagram 201 of physical venue 201, in which system 100 in FIG. 1 is utilized, according to one implementation. As shown in FIG. 2, user device 240 includes projection unit 248 emitting light beam 206, and P/L detection unit 244. User device 240 is aimed or pointed towards object representation 216, which may be in motion across arbitrarily shaped surface 236 (hereinafter “surface 236”) within the physical venue 201. Also shown in FIG. 2 is collision 232 of light beam 206 with object representation 216 moving on surface 236, as well as camera 202 used to detect collision 232.

It is noted that physical venue 201 including surface 236, object representation 216, and collision 232 corresponds in general to physical venue 101 including surface(s) 136, object representations 116a and 116b, and collisions 132a and 132b in FIG. 1. Consequently, physical venue 201, surface 236, object representation 216, and collision 232 may share any of the characteristics attributed to respective physical venue 101, surface(s) 136, object representations 116a and 116b, and collisions 132a and 132b by the present disclosure, and vice versa. In other words, like surface(s) 136, surface 236 may include one or more arbitrarily shaped surfaces; like object representations 116a and 116b, object representation 216 may include multiple object representations in the form of respective digital projections; and like collisions 132a and 132b, collision 232 may include multiple collisions between one or more light beams and an object representation.

In addition, user device 240, light beam 206 and camera 202, in FIG. 2, correspond respectively in general to user devices 140a and 140b, light beams 106a and 106b and camera(s) 102, in FIG. 1. Thus, user device 240, light beam 206 and camera 202 may share any of the characteristics attributed to respective user devices 140a and 140b, light beams 106a and 106b and camera(s) 102, by the present application, and vice versa. That is to say, like camera(s) 102, camera 202 may include one or more IR-sensitive still image cameras and/or video cameras, as well as one or more RGB still image cameras and/or video cameras. . . . Moreover, like user device 240, user devices 140a and 140b may each include projection unit 248 implemented as an IR light source producing light beam 206 as an IR light beam, and P/L detection unit 244 in the form of an IMU.

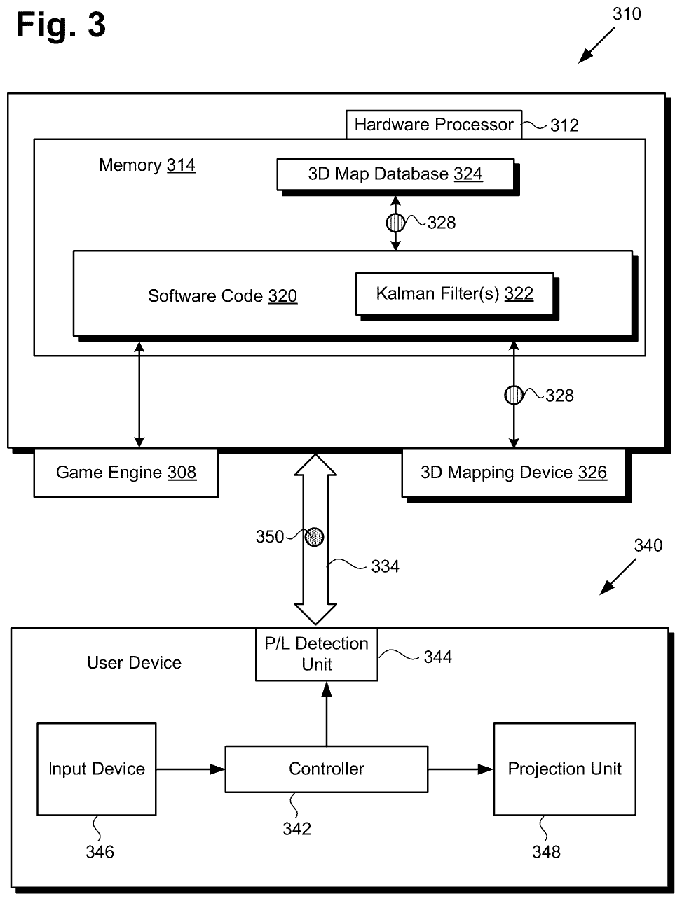

FIG. 3 shows a more detailed diagram of user device 340, communicatively coupled to computing platform 310, according to one implementation. As shown in FIG. 3, computing platform 310 includes hardware processor 312 and memory 314 implemented as a non-transitory storage medium. In addition, in some implementations, computing platform 310 may optionally include one or both of game engine 308 and 3D mapping device 326. As further shown in FIG. 3, memory 314 of computing platform 310 stores software code 320 including one or more Kalman filters 322 (hereinafter “Kalman filter(s) 322”), and may further store 3D map database 324 having stored therein 3D map 328 of physical venue 101/201 shown in FIGS. 1 and 2.

User device 340 includes controller 342, P/L detection unit 344, input device 346 and projection unit 348. Also shown in FIG. 3 are wireless communication link 334 and orientation data 350 received by computing platform 310 from user device 340 via wireless communication link 334.

Computing platform 310, hardware processor 312, memory 314, software code 320, game engine 308 and 3D mapping device 326 correspond respectively in general to computing platform 110, hardware processor 112, memory 114, software code 120, game engine 108 and 3D mapping device 126, in FIG. 1. Thus, computing platform 110, hardware processor 112, memory 114, software code 120, game engine 108 and 3D mapping device 126 may share any of the characteristics attributed to respective computing platform 310, hardware processor 312, memory 314, software code 320, game engine 308 and mapping device 326 by the present disclosure, and vice versa. Thus, like software code 320, software code 120 may include Kalman filter(s) 322, while, in some implementations memory 114 may include 3D map database 324. Moreover, it is noted that although not shown in FIG. 3, like computing platform 110, computing platform 310 is communicatively coupled to camera(s) 102 as part of system 100.

User device 340 corresponds in general to either of user devices 140a or 140b in FIG. 1, as well as to user device 240, in FIG. 2. Consequently, user device 140a/140b/240 may share any of the characteristics attributed to user device 340 by the present disclosure, and vice versa. That is to say, like user device 340, user device 140a/140b may include controller 342, P/L detection unit 344, input device 346 and projection unit 348, while, in addition to P/L detection unit 244 and projection unit 248, user device 240 may also include controller 342 and input device 346.

Moreover, P/L detection unit 344 and projection unit 348 correspond respectively in general to P/L detection unit 244 and projection unit 248, in FIG. 2. Thus, P/L detection unit 244 and projection unit 248 may share any of the characteristics attributed to respective P/L detection unit 344 and projection unit 348 by the present disclosure, and vice versa. P/L detection unit 244/344 may include one or more or of an accelerometer or accelerometers, a gyroscope or gyroscopes, a Global Positioning System (GPS) receiver or receivers, and a magnetometer of magnetometers, for example. In some implementations, as noted above, P/L detection unit 244/344 may be implemented as an IMU. Projection unit 248/348 may be an IR light source, such as an IR laser or LED, for example, producing light beam 106a/106b/206 as an IR light beam, while input device 346 may be any manual actuator, such as a pushbutton, switch, or trigger for example.

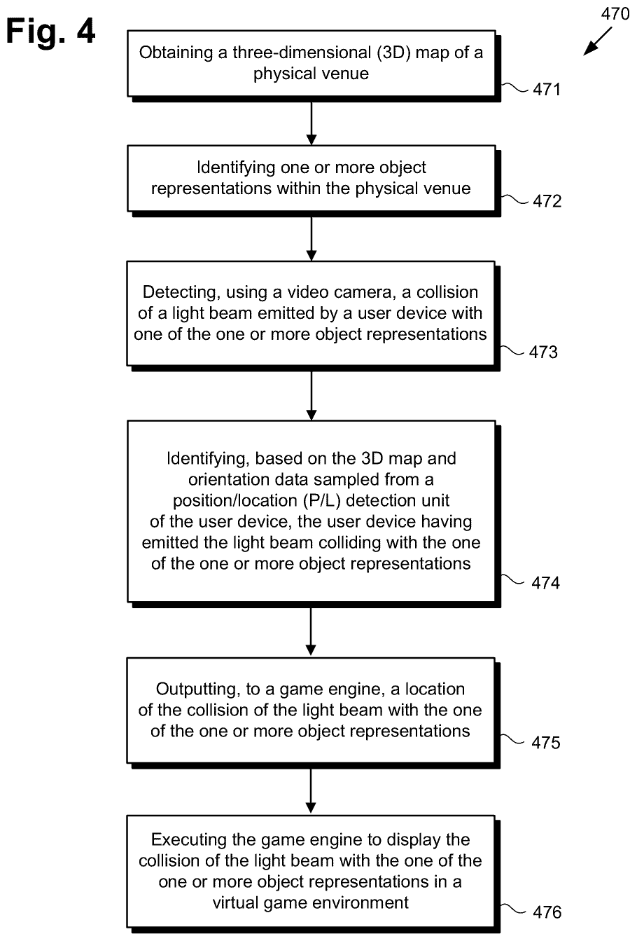

The functionality of system 100, in FIG. 1, will be further described by reference to FIG. 4. FIG. 4 shows flowchart 470 presenting an exemplary method for performing high frame rate light beam collision detection, according to one implementation. With respect to the actions outlined in FIG. 4, it is noted that certain details and features have been left out of flowchart 470 in order not to obscure the discussion of the inventive features in the present application.

Referring to FIG. 4 in combination with FIGS. 1, 2 and 3, flowchart 470 begins with obtaining 3D map 328 of physical venue 101/201 (action 471). In some use cases, 3D map 328 of physical venue 101/201 may be stored in 3D map database 324. In those use cases, hardware processor 112/312 of computing platform 110/310 may execute software code 120/320 to obtain 3D map 323 of physical venue 101/201 by retrieving 3D map 328 from 3D map database 324 in action 471.

However, and as noted above, in some implementations, system 100 may include optional 3D mapping device 126/326. 3D mapping device 126/326 may include a camera, such as a three hundred and sixty degree (360°) camera, a camera array, or one or more other types of optical sensors for mapping physical venue 101/201. Alternatively, or in addition, 3D mapping device 126/326 may include a light detection and ranging (LIDAR) device for mapping physical venue 101/201. Thus, in some implementations, obtaining 3D map 328 of physical venue 101/201, in action 471, may be performed by software code 120/320 of computing platform 110/310, executed by hardware processor 112/312, and using 3D mapping device 126/326 to generate 3D map 328 of physical venue 101/201.

Continuing to refer to FIG. 4 in combination with FIGS. 1, 2 and 3, flowchart 470 further includes identifying object representation(s) 116a/116b/216 within physical venue 101/201 (action 472). As noted above, object representations 116a/116b/216 may be digital representations of respective objects that are projected onto surface(s) 136 of physical venue 101/201, such as arbitrary 3D surfaces within physical venue 101/201. Moreover, and as further noted above, each of object representations 116a/116b/216 may be in motion within physical venue 101/201, moving with velocity 118a or 118b for example.

The identification of object representation(s) 116a/116b/216 within physical venue 101/201 may be performed by software code 120/320, executed by hardware processor 112/312 of computing platform 110/310, and using one or more of camera(s) 102/202. As described above by reference to FIGS. 1 and 2, camera(s) 102/202 may include one or more IR-sensitive still image cameras and/or video cameras, as well as one or more RGB still image cameras and/or video cameras.

Continuing to refer to FIG. 4 in combination with FIGS. 1, 2 and 3, flowchart 470 further includes detecting, using one or more video cameras included among camera(s) 102/202, a collision (hereinafter “collision 132a/232”) of a light beam (hereinafter “light beam 106a/206”) emitted by a user device (hereinafter “user device 140a/240/340”) with one of object representations 116a/116b/216 (hereinafter “object representation 116a/216”) (action 473). As noted above, user device 140a/240 may include projection unit 248/348 including an IR emission source, such as an IR laser or LED, for example, configured to emit light beam 116a/216 as IR light. One or more IR-sensitive video cameras included among camera(s) 102/202 may be utilized by system 100 to detect collision 132a/232 in action 473. That is to say, collision 132a/232 of light beam 106a/206 emitted by user device 140a/240/340 with object representation 116a/216 may be detected, in action 473, by software code 120/320, executed by hardware processor 112/312 of computing platform 110/310, and using one or more video cameras of camera(s) 102/202.

Continuing to refer to FIG. 4 in combination with FIGS. 1, 2 and 3, flowchart 470 further includes identifying, based on 3D map 328 and orientation data 150a/350 sampled from P/L detection unit 244/344 of user device 140a/240/340, user device 140a/240/340 as the user device having emitted light beam 106a/206 colliding with object representation 116a/216 (action 474). Action 474 may be performed by software code 120/320, executed by hardware processor 112/312 of computing platform 110/310, and using Kalman filter(s) 322.

For example, Kalman filter(s) 322 may be specifically configured to synchronize image data 104 sampled from the one or more video cameras of camera(s) 102/202 used in action 473, with orientation data 150a/350 sampled from P/L detection unit 244/344 of user device 140a/240/340. Kalman filter(s) 322 may be used to upscale light beam collision measurements sampled from camera(s) 102 and fuse that image data 104 with orientation data 150a/350 sampled from P/L detection unit 244/344 of user device 140a/240/340. Estimates of the position of each light beam collision can then be made between light detection measurements, using orientation data 150a/350, which may be sampled more frequently than image data 104. That is to say, image data 104 and orientation data 150a/350 may be sampled at different sampling rates.

It is noted that actions 473 and 474 refer to a single user device, i.e., user device 140a/240/340. However, and as noted above, it is contemplated that in most use cases, multiple users utilizing multiple user devices will interact contemporaneously with features of physical venue 101/201, such as ten, fifty, or one hundred users corresponding to users 130a and 130b each utilizing a respective one of ten, fifty, or one hundred user devices corresponding to user devices 140a/140b/240/340. In use cases in which two user devices are in use contemporaneously, for example, action 473 described above further includes detecting, by software code 120/320 executed by hardware processor 112/312 and using camera(s) 102/202, a second collision (hereinafter “collision 132b/232”) of a second light beam (hereinafter “light beam 106b/206”) emitted by a second user device (hereinafter “user device 140b/240/340”) with another one of object representations 116a/116b/216 (hereinafter “object representation 116b/216”).

Furthermore, in use cases in which two user devices are in use contemporaneously, action 474 further includes identifying, by software code 120/320 executed by hardware processor 112/312, based on 3D map 328 and a second orientation data (hereinafter “orientation data 150b/350 sampled from P/L detection unit 244/344 of user device 140b/240/340), user device 140b/240/340 as the user device having emitted light beam 106b/206 colliding with object representation 116b/216.

For example, Kalman filter(s) 322 may be used to upscale light beam collision measurements sampled from camera(s) 102 and fuse that image data 104 with orientation data 150b/350 sampled from P/L detection unit 244/344 of user device 140b/240/340. Estimates of the position of each light beam collision can then be made between light detection measurements, using orientation data 150b/350, which may be sampled more frequently than image data 104.

In some use cases, the method outlined by flowchart 470 may conclude with action 474 described above. However, and referring once again to FIG. 4 in combination with FIGS. 1, 2 and 3, as noted above, in some implementations, system 100 may include game engine 108/308. In those implementations, game engine 108 may be configured to generate a virtual game environment corresponding to physical venue 101/201. Moreover, in those implementation, as further shown by FIG. 4, flowchart 470 may also include outputting, to game engine 108/308, the location of collision 132a/232 of light beam 106a/207 with object representation 116a/216, as well as, in some implementations, the location of collision 132b/232 of light beam 106b/207 with object representation 116b/216 (action 475). Action 475 may be performed by software code 120/320, executed by hardware processor 112/312 of computing platform 110/310.

Continuing to refer to FIGS. 1, 2, 3 and 4 in combination, in some implementations, flowchart 470 further includes, executing, by hardware processor 112/312 of computing platform 110/310, game engine 108/308 to display collision 132a/232 of light beam 106a/207 with object representation 116a/216, or collision 132a/232 of light beam 106a/207 with object representation 116a/216 and collision 132b/232 of light beam 106b/207 with object representation 116b/216, in the virtual game environment corresponding to physical venue 101/201 and generated by game engine 108/308 (action 476). With respect to the method outlined by flowchart 470, it is noted that actions 471, 472, 473 and 474 (hereinafter “actions 471-474”), or actions 471-474 and 475, or actions 471-474, 475 and 476, may be performed in an automated method from which human intervention may be omitted.

Thus, the present application is directed to high frame rate light beam collision detection systems and methods that address and overcome the deficiencies in the conventional art. The novel and inventive concepts disclosed in the present application advance the state-of-the-art by synchronizing image data sampled from one or more video cameras with orientation data sampled from a P/L detection unit of a respective user device utilized by each of multiple users. That synchronized image and orientation data can advantageously be used to identify the particular user device that emitted a light beam having collided with an object representation in the form of a digital projection that may move across arbitrary surfaces in a 3D physical venue.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a hardware processor and a memory storing a software code;
a video camera communicatively coupled to the computing platform; and
a user device communicatively coupled to the computing platform, the user device including a position/location (P/L) detection unit;
the hardware processor configured to execute the software code to:
obtain a three-dimensional (3D) map of a physical venue;
identify one or more object representations within the physical venue;
detect, using the video camera, a collision of a light beam emitted by the user device with one of the one or more object representations; and
identify, based on the 3D map and an orientation data sampled from the P/L detection unit, the user device having emitted the light beam colliding with the one of the one or more object representations.

2. The system of claim 1, wherein the one or more object representations comprise one or more digital representations of one or more respective objects.

3. The system of claim 1, wherein each of the one or more object representations is in motion within the physical venue.

4. The system of claim 1, wherein the one or more object representations are presented on an arbitrarily shaped surface, and wherein detecting detects the collision of the light beam emitted by the user device with a location on the arbitrarily shaped surface corresponding to the one of the one or more object representations.

5. The system of claim 1, wherein the software code comprises one or more Kalman filters configured to synchronize image data sampled from the video camera with the orientation data sampled from the P/L detection unit.

6. The system of claim 5, wherein the image data and the orientation data are sampled at different sampling rates.

7. The system of claim 1, further comprising a second user device communicatively coupled to the computing platform, the second user device including a second P/L detection unit, wherein the hardware processor is further configured to execute the software code to:
detect, using the video camera, a second collision of a second light beam emitted by the second user device with another one of the one or more object representations; and
identify, based on the 3D map and a second orientation data sampled from the second P/L detection unit, the second user device having emitted the second light beam colliding with the another one of the one or more object representations.

8. The system of claim 1, further comprising a game engine configured to generate a virtual game environment corresponding to the physical venue.

9. The system of claim 8, wherein the hardware processor is further configured to execute the software code to output, to the game engine, a location of the collision of the light beam with the one of the one or more object representations.

10. The system of claim 9, wherein the hardware processor is further configured to execute the game engine to display the collision of the light beam with the one of the one or more object representations in the virtual game environment.

11. A method for use by a system including a computing platform having a hardware processor and a memory storing a software code, a video camera communicatively coupled to the computing platform and a user device communicatively coupled to the computing platform, the user device including a position/location (P/L) detection unit, the method comprising:
obtaining, by the software code executed by the hardware processor, a three-dimensional (3D) map of a physical venue;
identifying, by the software code executed by the hardware processor, one or more object representations within the physical venue;
detecting, by the software code executed by the hardware processor and using the video camera, a collision of a light beam emitted by the user device with one of the one or more object representations; and
identifying, by the software code executed by the hardware processor based on the 3D map and an orientation data sampled from the P/L detection unit, the user device having emitted the light beam colliding with the one of the one or more object representations.

12. The method of claim 11, wherein the one or more object representations comprise one or more digital representations of one or more respective objects.

13. The method of claim 11, wherein each of the one or more object representations is in motion within the physical venue.

14. The method of claim 11, wherein the one or more object representations are presented on an arbitrarily shaped surface, and wherein detecting detects the collision of the light beam emitted by the user device with a location on the arbitrarily shaped surface corresponding to the one of the one or more object representations.

15. The method of claim 11, wherein the software code comprises one or more Kalman filters configured to synchronize image data sampled from the video camera with the orientation data sampled from the P/L detection unit.

16. The method of claim 15, wherein the image data and the orientation data are sampled at different sampling rates.

17. The method of claim 11, wherein the system further comprising a second user device communicatively coupled to the computing platform, the second user device including a second P/L detection unit, the method further comprising:
detecting, by the software code executed by the hardware processor and using the video camera, a second collision of a second light beam emitted by the second user device with another one of the one or more object representations; and
identifying, by the software code executed by the hardware processor based on the 3D map and a second orientation data sampled from the second P/L detection unit, the second user device having emitted the second light beam colliding with the another one of the one or more object representations.

18. The method of claim 11, further comprising a game engine configured to generate a virtual game environment corresponding to the physical venue.

19. The method of claim 18, further comprising:
outputting to the game engine, by the software code executed by the hardware processor, a location of the collision of the light beam with the one of the one or more object representations.

20. The method of claim 19, further comprising:
executing the game engine, by the hardware processor, to display the collision of the light beam with the one of the one or more object representations in the virtual game environment.
